(19) United States
(12) Patent Application Publication
(10) Pub. No.: US 2022/0245742 A1
(43) Pub. Date: Aug. 4, 2022

(54) METHOD AND SYSTEM FOR MATCHING COMMERCIAL PROPERTIES AND TENANTS

(71) Applicant: Michael Ziegler, Ashburn, VA (US)

(72) Inventor: Michael Ziegler, Ashburn, VA (US)

(21) Appl. No.: 17/219,928

(22) Filed: Apr. 1, 2021

Related U.S. Application Data
(60) Provisional application No. 63/143,115, filed on Jan. 29, 2021.

(51) Int. Cl. G06Q 50/16; G06Q 30/06; G06F 16/29; G06Q 30/02; G06F 16/9535

(52) U.S. Cl. CPC G06Q 50/16; G06Q 30/0645; G06F 16/9535; G06Q 30/0201; G06F 16/29

(57) ABSTRACT

Systems, methods, and computer program products for matching commercial properties and tenants. Property attribute and tenant requirement data is collected in a central database and indexed to or stored in respective property and tenant entries. Each property or tenant entry is compared to a plurality of tenant or property entries, respectively, and a match score determined for each property-tenant entry pair. Property-tenant entry pairs for a particular property or tenant are ranked based on the match scores of the property-tenant pairs, and a list of best matches compiled. A record listing the best matching property or tenant records is then transmitted to an electronic address of the property owner or tenant. A lead generation process may run periodically, continuously, or in response to an event, to update matches between property entries and tenant entries in the database.

This application claims the benefit of U.S. Application No. 63/143,115,filed on Jan. 29, 2021 and entitled “Method and System for Matching Commercial Properties and Tenants”, the disclosure of which is incorporated by reference herein in its entirety.

BACKGROUND

This invention generally relates to computer database systems and, in particular, to methods, systems, and computer program products for matching commercial tenants with commercial real estate properties.

While the physical characteristics of properties, demographic information, traffic counts, and tenant requirements are sometimes stored in separate database or search platforms, use of this data is currently limited to within each separate platform. The process of finding occupants for vacant property is thus very arduous and involves significant trial and error in attempting to contact possible tenants only to find that the property in some way doesn't fit the tenant's requirements. As more data has become available, the process of matching a tenant to a property has become more cumbersome. Attempts have been made to shortcut the disjointed nature of the processes involved in matching tenants and properties. However, no known solution has been able to integrate all of the elements considered by tenants into an optimized system for computer database searching of properties that match tenants.

Thus, there is a need for improved systems, methods, and computer program products which enable the compilation, searching, and processing of data relating to the physical characteristics of properties, demographic information, traffic counts, and tenant requirements together in such a way that the information is processed collectively to match tenants and properties.

SUMMARY

In an embodiment of the invention, a system is provided. The system includes one or more processors, and a memory operatively coupled to the one or more processors. The memory includes program code that, when executed by the one or more processors, causes the system to maintain a database including a plurality of property entries and a plurality of tenant entries. Each property entry defines one or more attributes of a property, and each tenant entry defines one or more requirements of a tenant. The program code causes the system to select a first entry from one of the plurality of property entries or the plurality of tenant entries, and for each entry of the other of the plurality property entries or the plurality tenant entries, compare each attribute or each requirement of the first entry to each requirement or each attribute of the other entry. The program code further causes the system to determine a match score based on the comparisons between the attributes and the requirements, generate a match record in the database including the match score, and associate the match record with a property-tenant entry pair defined by the first entry and the other entry. The program code further causes the system to generate a first report identifying one or more properties or one or more tenants that match the property or the tenant associated with the first entry.

In an aspect of the invention, the attributes may include at least one of property data, traffic data, demographic data, address data, and location data.

In another aspect of the invention, the program code may further cause the system to determine the match score by, for each requirement, determining if a corresponding attribute satisfies the requirement. If the corresponding attribute satisfies the requirement, the program code may cause the system to increase a value of the match score. If the corresponding attribute does not satisfy the requirement, the program code may cause the system to not increase the value of the match score.

In another aspect of the invention, an amount the value of the match score is increased may depend at least in part on a type of the requirement being satisfied.

In another aspect of the invention, an amount the value of the match score is increased may depend at least in part on a weight associated with the requirement being satisfied.

In another aspect of the invention, the first report may be a property report, the first entry may be a property entry, each of the other entries may be a tenant entry, and the program code may further cause the system to rank the tenant entries based on the match scores, select one or more of the tenant entries based their rank, and generate the property report that includes the one or more of the tenant entries.

In another aspect of the invention, the first report may be a tenant report, the first entry may be a tenant entry, each of the other entries may be a property entry, and the program code may further cause the system to rank the property entries based on the match scores, select one or more property entries based their rank, and generate a tenant report that includes the one or more property entries.

In another aspect of the invention, the program code may further cause the system to, for each entry of the other of the plurality property entries or the plurality tenant entries, determine if the match record exists for the property-tenant entry pair. In response to the match record existing for the property-tenant entry pair, the program code may cause the system to determine if the match record is current, and if the match record does not exist, or is not current, generate a new match record.

In another aspect of the invention, the program code may further cause the system to scan the database for reports associated with either a property entry or a tenant entry of the property-tenant entry pair associated with each new match record. For each report identified by the scan, the program code may cause the system to rank the tenant entries or the property entries based on the match score of each property-tenant entry pair associated with the property entry or the tenant entry with which the report is associated. The program code may then cause the system to select one or more of the tenant entries or the property entries based their rank, and in response to the one or more tenant entries or the one or more property entries including a new entry, generate a new report that includes the one or more tenant entries or the one or more property entries.

In another aspect of the invention, the program code may further cause the system to, in response to generation of each new report, transmit the new report to an electronic address associated with the property entry or the tenant entry to which the new report is associated.

In another embodiment of the invention, a method is provided. The method includes maintaining the database that includes the plurality of property entries and the plurality of tenant entries, each property entry defining one or more attributes of a property, and each tenant entry defining one or more requirements of a tenant. The method further includes selecting the first entry from one of the plurality of property entries or the plurality of tenant entries, and for each entry of the other of the plurality property entries or the plurality tenant entries, comparing each attribute or each requirement of the first entry to each requirement or each attribute of the other entry. The method further includes determining the match score based on the comparisons between the attributes and the requirements, generating the match record in the database including the match score, and associating the match record with the property-tenant entry pair defined by the first entry and the other entry. The method then generates the first report identifying the one or more properties or the one or more tenants that match the property or the tenant associated with the first entry.

In an aspect of the invention, determining the match score may include, for each requirement, determining if the corresponding attribute satisfies the requirement. If the corresponding attribute satisfies the requirement, the method may increase the value of the match score, and if the corresponding attribute does not satisfy the requirement, the method may not increase the value of the match score.

In another aspect of the invention, the first report may be a property report, the first entry may be a property entry, each of the other entries may be a tenant entry, and the method may further include ranking the tenant entries based on the match scores, selecting the one or more of the tenant entries based their rank, and generating the property report that includes the one or more of the tenant entries.

In another aspect of the invention, the first report may be a tenant report, the first entry may be a tenant entry, each of the other entries may be a property entry, and the method may further include ranking the property entries based on the match scores, selecting one or more property entries based their rank, and generating the tenant report that includes the one or more property entries.

In another aspect of the invention, the method may further include, for each entry of the other of the plurality property entries or the plurality tenant entries, determining if the match record exists for the property-tenant entry pair. In response to the match record existing for the property-tenant entry pair, the method may determine if the match record is current, and if the match record does not exist, or is not current, generate the new match record.

In another aspect of the invention, the method may further include scanning the database for reports associated with either the property entry or the tenant entry of the property- tenant entry pair associated with each new match record. For each report identified by the scan ranking the tenant entries or the property entries based on the match score of each property- tenant entry pair associated with the property entry or the tenant entry with which the report is associated, the method may select one or more of the tenant entries or the property entries based their rank. In response to the one or more tenant entries or the one or more property entries including the new entry, the entry may generate the new report that includes the one or more tenant entries or the one or more property entries, and in response to generation of each new report, transmit the new report to an electronic address associated with the property entry or the tenant entry to which the new report is associated.

In another embodiment of the invention, a computer program product is provided. The computer program product includes a non-transitory computer-readable storage medium, and program code stored on the non-transitory computer-readable storage medium. When executed by one or more processors, the program code causes the one or more processors to maintain the database that includes the plurality of property entries and the plurality of tenant entries, each property entry defining the one or more attributes of the property, and each tenant entry defining the one or more requirements of the tenant. The computer program code further causes the one or more processors to select the first entry from the one of the plurality of property entries or the plurality of tenant entries. For each entry of the other of the plurality property entries or the plurality tenant entries, the program code causes the one or more processors to compare each attribute or each requirement of the first entry to each requirement or each attribute of the other entry, determine the match score based on the comparisons between the attributes and the requirements, generate the match record in the database including the match score, and associate the match record with a property-tenant entry pair defined by the first entry and the other entry. The program code further causes the one or more processors to generate the first report identifying the one or more properties or the one or more tenants that match the property or the tenant associated with the first entry.

The above summary presents a simplified overview of some embodiments of the invention to provide a basic understanding of certain aspects of the invention discussed herein. The summary is not intended to provide an extensive overview of the invention, nor is it intended to identify any key or critical elements, or delineate the scope of the invention. The sole purpose of the summary is merely to present some concepts in a simplified form as an introduction to the detailed description presented below.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is a diagrammatic view of an exemplary operating environment including data sources and a data management system.

FIG. 2 is a flowchart of a process for collecting property information in the data management system of FIG. 1.

FIG. 3 is a flowchart of a process for compiling demographic information in the data management system of FIG. 1.

FIG. 4 is a flowchart of a process for matching property and tenant entries in the data management system of FIG. 1.

FIG. 5 is a flowchart of a process for updating matches between property and tenant entries in the data management system of FIG. 1.

FIG. 6 is a diagrammatic view of a computer that may be used to implement one or more of the systems or processes shown in FIGS. 1-5.

It should be understood that the appended drawings are not necessarily to scale, and may present a somewhat simplified representation of various features illustrative of the basic principles of the invention. The specific design features of the sequence of operations disclosed herein, including, for example, specific dimensions, orientations, locations, and shapes of various illustrated components, may be determined in part by the particular intended application and use environment. Certain features of the illustrated embodiments may have been enlarged or distorted relative to others to facilitate visualization and a clear understanding. In particular, thin features may be thickened, for example, for clarity or illustration.

### DETAILED DESCRIPTION

Embodiments of the invention are directed to systems, methods, and computer program products that provide a matching service to property owners and tenants. The service collects data defining property attributes, which may include characteristics of the property itself (e.g., size and location) as well as demographic characteristics and traffic patterns for the area around the property. The property attributes may be stored in a database. The service compares property attributes with tenant requirements, and identifies matches between tenant entries and property entries in the database based on this comparison. The service may then provide users (e.g., property owners and tenants) with a report including match criteria and prospective property-tenant matches. Embodiments of the invention may also search the database for new matches between property and tenant entries as additional information is added or changes are made to the database, and provide feedback to users regarding new matches. Embodiments of the invention may compile the property attributes and tenant requirements, including demographic information and traffic counts, into one dataset, compare all of the information to create a match for each of those tenants who are best suited for the property, and continually comb the database for new matches as information is added or changed.

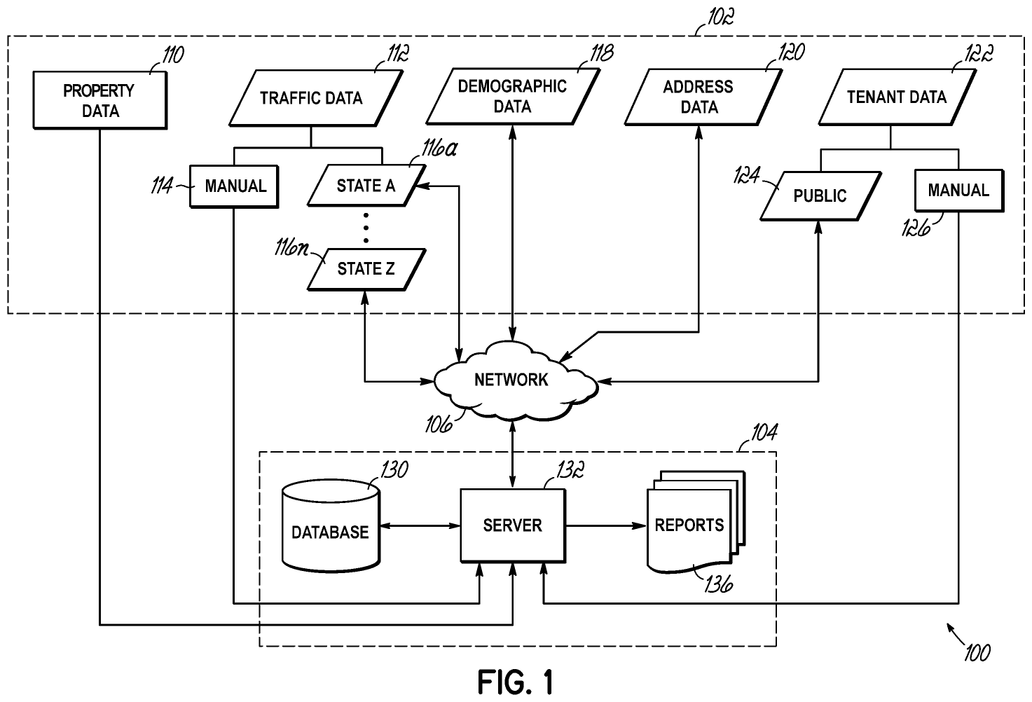

FIG. 1 depicts an operating environment 100 in accordance with an embodiment of the invention that includes a plurality of data sources 102, a data management system 104, and a network 106 over which the data management system 104 communicates with one or more of the data sources 102. The network 106 may include one or more data networks such as a local area network (LAN), a wide area network (WAN), a wireless network (e.g., Wi-Fi or cellular network), the Internet, or any other suitable network for transmitting data between one or more of the data sources 102 and the data management system 104.

Exemplary data sources 102 may include, but are not limited to, property data 110, traffic data 112, demographic data 118, address data 120, and tenant data 122. The data sources 102 may include data from various industries, entities, or users, and may contain information that relates to one or more commercial properties. The data management system 104 may include a database 130 that stores and manages data received from the data sources 102, and a data management server 132. Data may be collected from the data sources 102 and entered into the data management system 104 in any suitable manner. The data management server 132 may provide a user interface for the data management system 104, and generate data management reports 136 based at least in part on information stored in the database 130.

Data from data sources 102 may be manually entered into the database 130 (e.g., through the user interface of data management system 104), downloaded from an existing pool of data, or added to the database 130 through a combination of manual entry and downloading. For example, the property data 110 may be primarily entered into the data management system 104 manually, e.g., by the property owner via the user interface of data management system 104. Property data 110 may define a variety of physical and business-oriented information about a commercial property. Exemplary business-oriented information may include, but is not limited to, building condition, number of curb cuts or curb accesses, number of parking spaces, type of parking (e.g., surface, garage, valet), building dimensions (e.g., depth, max ceiling height, clear span), available space, building total square footage, available space size, available space rental rate (cost per square foot or total for space per month/year), lease type (triple net cost, gross, etc.), whether property is end-cap or in-line, space delivery options, fire prevention (e.g., presence of a sprinkler system or other fire suppression system), available space frontage, available space docks, drive-thru availability, drive-thru addition capability, tenant improvement allowance for the space (e.g., dollars per square foot or for total leased area), lease term (years, months), seating count, utilities (e.g., electric service capacity (amps), water service capacity (pipe size), natural gas capacity (pipe size), heating ventilation and air conditioning (HVAC) capacity (e.g., tonnage)), whether an exclusive lease is available, a lease guarantor, property size (e.g., number of acres), and whether the property includes an existing structure or is an empty lot.

Traffic data 112 may be entered manually 114 or downloaded from existing pools of data, such as state-provided data sources 116a-116n, depending on the nature of the traffic data. Traffic data 112 may include, but is not limited to, traffic patterns and traffic counts. Initially, a traffic count for the property may be entered by the property owner or broker, but this process may also be automated by integrating data from existing databases. Existing databases of traffic data may include state-provided traffic data sources 116a-116n, such as a state Department of Transportation (DOT) database. State-provided traffic data sources 116a-116n may be available for one or more states where a commercial property processed by the data management system 104 is located (e.g., New York State's www.511ny.org traffic Application Programming Interface (API)). State-provided traffic data sources 116a-116n may also be sourced from regional or municipal systems, such as the Department of Transportation data for the City of New York available at www.data.cityofnewyork.us.

Traffic counts may be measured, for example, from the principal intersection closest to the property. Traffic count data may be obtained manually (e.g., from observations made by a person viewing the intersection over time), or downloaded from a state-provided system. To obtain data from state-provided traffic data sources 116a-116n, the data management system 104 may transmit a request including a location of the nearest principal intersection to the appropriate system. The data management system 104 may then receive data from the appropriate system as a response to the request. Regardless of how the data management system 104 receives traffic data 112, in response to receiving the data, the data management system 104 may store the traffic data 112 in the database 130.

Demographic data 118 and address data 120 may be obtained from an existing pool of data based on the geographic location or address of the property. Existing pools of demographic data 118 may include those provide by a third-party service, such as ERSI of Redlands, California. Examples of demographic data 118 may include, but are not limited to, the number of households and distance-based daytime population, current year information for population, household income (average, median), and average household size.

Existing pools of address data 120 may include third-party service, such as MAPBOX of San Francisco, Calif. Address data 120 may include, for example, the coordinates (i.e., latitude and longitude) of the commercial property as well as verified addresses that most closely match the address provided for the commercial property.

Tenant data 122 may be collected from public sources 124, through manual entry 126, or both public sources and manual entry 126. Information may be collected from the tenant, for example, by inviting the tenant to join the service via a phone call or email, and directing the tenant to create an account on a website. The website may be hosted by the data management server 132, or a web-server in communication with the data management server 132. Other tenants may discover the website and enter data on their own without solicitation. In either case, the website may prompt the tenant to manually enter tenant information, e.g., by presenting a tenant form that asks a series of questions. Tenant information may be associated with a tenant account in the database 130 so that the tenant can access and modify criteria as necessary by changing their answers on the tenant form.

Public sources 124 of tenant data may include various sources of public information. Examples of these sources may include printed materials, web searches, web-scraping, or personal communications. The public information may be entered via the user interface of data management system 104, e.g., by an employee of the service. Public information may also be automatically collected from the various sources and downloaded into the data management system 104. Public sources 124 of tenant data may be used to supplement data provided by a tenant, or to identify a potential tenant. The data management system 104 may then solicit potential tenants via email or telephonic communication to become a new user of the service.

Tenant data 122 may describe desired property attributes for a tenant that is searching for available commercial property to buy or lease. Tenant data 122 may also serve as or define a portion of the match criteria against which available properties are compared. Thus, tenant data 122 may include many of the same types information as the property data 110, traffic data 112, demographic data 118, and address data 120.

The database 130 may be accessed by the data management server 132 to store and retrieve information received from the data sources 102. The database 130 may also store reports 136 that are generated regarding property entries or tenant entries, and include records identifying users of the data management system 104 and associated contacts authorized to access the reports 136.

The data management server 132 may be configured to communicate with one or more of the data sources 102 using an application programming interface (API) or another suitable interface. The data management server 132 may receive information from the data sources 102 and store the information in the database 130. The data management server 132 may also generate the reports 136. These reports may be stored in the database 130, display to a user of the data management system 104 by the user interface of data management system 104, or electronically communicated to computer systems of users authorized to access the reports 136.

The reports 136 may be generated automatically or in response to a request, e.g., from a property owner, tenant, or other system user. The reports 136 may be stored in the database 130 for both future retrieval and updating. The data management server 132 may provide reports 136 to one or more users of the data management system 104, e.g., a tenant or property owner associated with the report 136. The reports may be provided upon generation, by request, or on a fixed schedule. This may occur by way of the user accessing the data management server 132 (e.g., via a web-based interface), or via an electronic communication (e.g., an e-mail with an attachment) sent to a contact address associated with the report 136.

In response to a tenant entering their data into the tenant form, the data management system 104 may establish a new tenant entry for the tenant in the database 130. The tenant entry may comprise one or more database records that store tenant data. The data management system 104 may also compile an attribute listing for the tenant based on desired attributes of the property the tenant is looking for. The tenant entry may include data such as contact information for the tenant, and data defining the tenant entry as belonging to a “tenant type” category, e.g., retail, food service, professional services, office, industrial, lodging, etc. The tenant entry may also include desired property attributes relating to demographic and traffic information. After creating a tenant entry, information relating to the property attributes desired by the tenant may be stored in one or more database records indexed to the tenant entry.

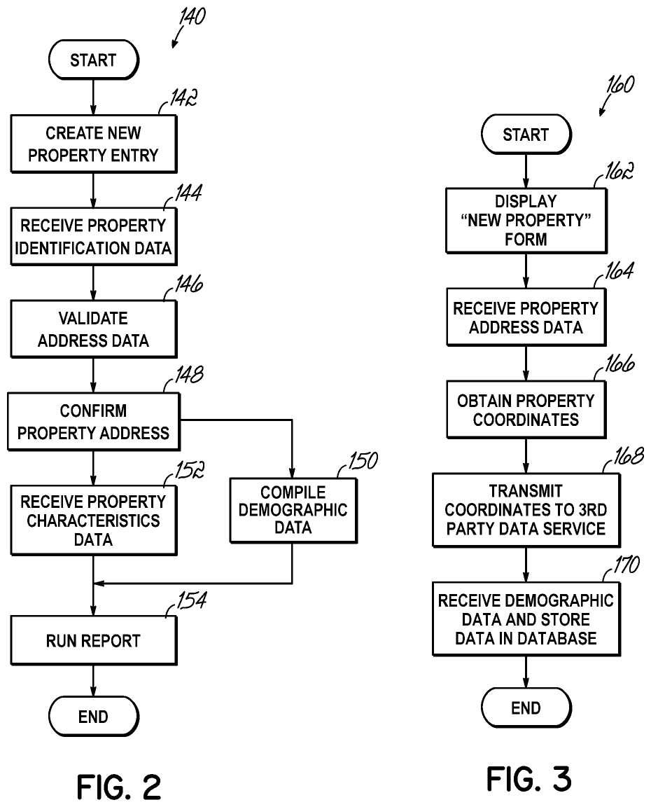

FIG. 2 depicts a flowchart illustrating an exemplary property information collection process 140 that may be executed by the data management system 104. The process 140 may establish a new property entry in the database 130, and compile an attribute listing for the property based on attributes compiled from various sources of information. These property attributes may include, for example, characteristics of the property itself, as well as demographic information and traffic counts for the area around the property.

In block 142, the process 140 may create a new property entry in the database 130. The new property entry may be created, for example, in response to receiving input indicating a user (e.g., a property owner) wishes to create the new property entry. The user may indicate they wish to add a new property, for example, by activating an “ADD NEW” button displayed by a user interface provided by the data management system 104, e.g., as a web-page. A single user (e.g., a property owner or broker) may have multiple property entries.

Once the property entry has been created, the process 140 may proceed to block 144 and receive property identification data. The property identification data may include data defining contact information for the property (e.g., the name, phone number, and email address of one or more people associated with the property), property name and address, and data identifying the entry as a ‘property type’ category. The data used to populate the property entry may be entered by the user into a property form, which may be similar to the tenant form described above. The user may indicate that they have finished entering the data into the new property form by activating a “NEXT” button.

In response to receiving the property identification data, the process 140 may proceed to block 146 and validate the address data. Validating the address data may include by transmitting a request (e.g., an API call) including the address data to a third-party map service, e.g., Mapbox. In response to receiving the request, the third-party map provider may determine the geographic coordinates of the supplied address, and a number of matching addresses proximate to those coordinates. The third-party map provider may then transmit a response to the process 140 including the coordinates and a list of the property addresses matching those coordinates.

In response to receiving the matching addresses, the process 140 proceed to block 148 and confirm the property address. To confirm the property address, the process 140 may cause the user interface to display the list of verified addresses to the user, e.g., as pins on a map. The user may then select a matching or most accurate address from the list of verified addresses. In response to the user selecting an address, the process 140 may cause the user interface to further display a map depicting the location of the selected address. The user may then use the map to adjust the location of the selected address. This feature may allow the user to to precisely correlate the selected address with the building corresponding to the property address, e.g., by placing a pin in the exact location of the building.

When the user is satisfied with the location, they may indicate this by activating a “NEXT” button. The process 140 may then store the property address and property coordinates (e.g., latitude and longitude) in the database 130 as location data for the property entry. In an alternative embodiment, rather than starting with a user provided address, the process 140 may validate and confirm address data by first receiving latitude and longitude coordinates for a new property (e.g., by the user placing a pin on a map), using the coordinates to identify a location of a building, and determining the matching address as being the address of the building. This address may then be added to the property entry in the database 130.

In response to the property address being confirmed, the process 140 may proceed to one or both of blocks 150 and 152. In block 150, the process 140 may compile demographic data. Compiling demographic data may include transmitting a request for demographic data to a third-party data service, e.g., ESRI. The request may be an API call that includes the coordinates of the property, which the third-party service may use to identify demographic data relevant to the location. Data relevant to the location may include data within one or more predetermine radiuses of the location, e.g., within one or more of a 1, 3, or 5-mile radius. In response to receiving the demographic data, the process 140 may store the demographic data in the database 130 as part of or indexed to a database record associated with the property entry.

In block 152, and optionally while the demographic data is being compiled, the process 140 may receive property characteristics data. Property characteristics data may include physical and business-oriented attributes of the property. This data may be entered by the user, for example, into a property form displayed by the user interface of data management system 104. In response to the user indicating the property characteristic data has been entered (e.g., activating a “NEXT” button on the property attribute form), the process 140 may store the property characteristic data in the database 130, e.g., in a data field of a database record associated with the property.

When the user has finished entering all the user provided data, the user may request a property report, e.g., by activating a “RUN REPORT” button. In response to the user requesting a property report, the process 140 may proceed to block 154, and compare the property attribute data (i.e., property location and characteristics, demographic data, and traffic data) with the requirements of prospective tenants. To this end, the process 140 may query the database 130 for the property attribute data. In cases where traffic data is missing from the property attributes in the database 130, the process 140 may transmit a request including a location of the nearest principal intersection to the appropriate system that stores the traffic information for the state in which the property is located. The process 140 may compile the different types of property attribute data into a property entry for comparison to one or more tenant entries in the database 130, each tenant entry defining a set of tenant requirements.

To find tenants for the report, the process 140 may query the database 130 for tenant entries whose criteria match the property entry. Match criteria for demographic data may include, but are not limited to, population, number of households, average household income, and daytime population within different distances, e.g., 1, 3 and 5-mile radiuses of the property. Other match criteria may include traffic counts measured from the nearest principal intersection to the property, as well as building characteristics and location. The process 140 may then include tenants having the highest match score with the property in question in the report.

FIG. 3 depicts a flowchart illustrating an exemplary demographic data compilation process 160 that may be executed by the data management system 104. The demographic data compilation process may be executed as part of another process (e.g., in in block 150 of process 140), or may be executed independently of other system processes.

In block 162, the process 160 may cause a user interface to display a “NEW PROPERTY” form. The NEW PROPERTY form may be displayed, for example, in response to a user activating a new property form button. In block 164, the process may receive the property address, e.g., from the user entering the property address into a data field of the NEW PROPERTY form. In response to receiving the address, the process 160 may proceed to block 166 and obtain coordinates (e.g., latitude and longitude) for the property. The coordinates may be obtained as described above, e.g., by transmitting a request to a third-party map provider, and receiving a response from the third-party map provider including the coordinates.

In response to obtaining the coordinates, the process 160 may proceed to block 168 and transmit a request for demographic data for the coordinates to the third-party data service. The third-party data service may validate the coordinates and retrieve the requested demographic data. The third-party data service may then transmit a response to the process 160 including all relevant demographic data for an area within one or more radiuses of the location identified by the coordinates.

In block 170, the process 160 may receive the response from the third-party data service, and store the demographic data for the property in question in the database 130. The database records in which the demographic data is stored may be indexed to a database record for the property entry to facilitate comparisons with tenant requirements.

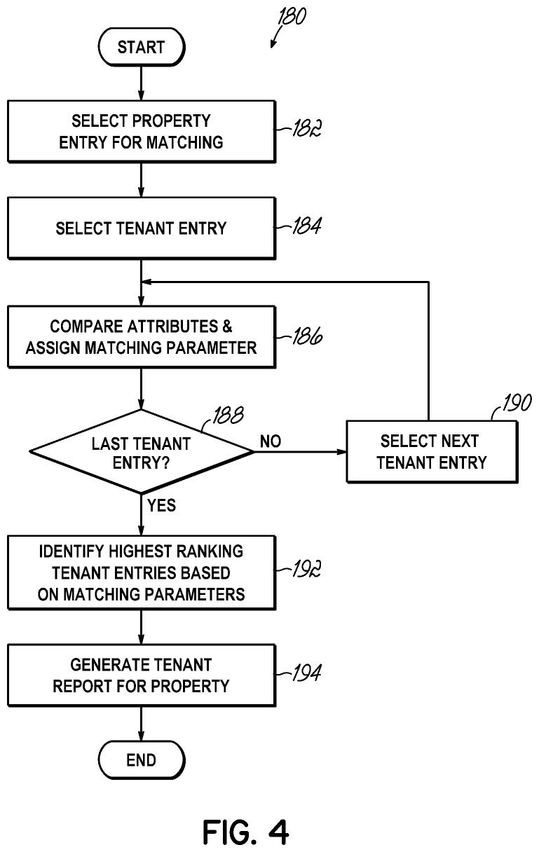

FIG. 4 depicts a flowchart illustrating an exemplary entry matching process 180 that may be executed by the data management system 104 to identify matches between properties and tenants. The matching process 180 is described below in terms of matching tenant entries to a selected property entry. However, the matching process 180 may also be configured to match property entries to a selected tenant entry. In either case, match scores between property entries and tenant entries defined by the matching process 180 and stored in the database 130 may be used to generate lists of prospective properties for display to tenants searching for a property, or to generate lists of prospective tenants for display to property owners searching for tenants.

In block 182, the process 180 may select a property entry to match with tenant entries in the database 130. The property entry may be defined by one or more records in the database 130 and identified for selection by a user through the user interface of the data management system 104. The property entry may also be selected in an automated manner, e.g., sequentially, randomly, or in response to an event such as an update to the database 130, the expiration of a timer, or any other suitable event.

In response to selecting the property entry, the process 180 may proceed to block 184 and select a tenant entry. The tenant entry may be selected randomly, based on a previous match with the property entry, based on how recently the tenant entry has been updated or added to the database, based on one or more “must have” tenant requirements being satisfied by the property attributes, or using any other suitable criteria. Once the tenant entry has been selected, the process 180 may proceed to block 186 and compare the required attributes associated with the tenant entry to the property attributes associated with the property entry. Based on this comparison, the process 180 may associate a match score with the property-tenant entry pair that defines a level of matching between the two entries. The algorithm that generates the value of the match score may be configured to define a level of matching between the tenant and the property. The match score may be used to identify which tenants would be the best prospects for leasing a specific property, or conversely, which properties would be the best prospects for a specific tenant to lease. The match score be added as metadata to one or more of the property and tenant entries, e.g., by storing it in a database record associated with each entry.

By way of example, the match score may be based on the number of attributes of the property entry that match the requirements of the tenant entry being processed, e.g., as a sum or count of the matching attributes. For example, a tenant entry may have a match score of three where there are three tenant requirements that match corresponding attributes of the property entry (e.g., type of parking =surface, max ceiling height =10ft, space delivery options =rear of building). One or more weighting factors may be used to increase the impact of certain attributes which are important to the tenant. As an additional example, a tenant entry may have a match score of five where there are tenant requirements having different weights (e.g., average age =below 30, weight =3; predominant marital status =single, weight =2) that match the corresponding attributes of the property entry (e.g., average age =25, predominant marital status =single).

In block 188, the process 180 may determine if the property entry has been compared to each tenant entry in the group of tenant entries being processed. If the present tenant entry is not the last one to be processed (“NO” branch of decision block 188), the process may proceed to block 190, select the nest tenant entry for processing, and return to block 186. If the present tenant entry is the last one to be processed (“YES” branch of decision block 188), the process may proceed to block 192.

In block 192, the process 180 may identify the tenant entries having the highest ranking based on match scores, and determine the tenants that best meet a match criteria for the property. The criteria for selecting which tenant entries to include in a tenant report may be based on, for example, identifying every tenant entry with a match score having a value above a certain number, a predetermined number of the highest ranked tenant entries, or any other suitable method of selecting tenant entries. Additional examples of methods of determining which tenant entries to include in the group of matching tenants may include a percentile-based method, defining a match criteria as the ‘top 5’ or ‘top 10’ matches, where the ‘5’ in ‘top 5’ and the ‘10’ in ‘top 10’ refer to either the five or ten tenant entries with the highest match scores, respectively.

In block 194, the process 180 may generate the tenant report for the property owner associated with the property entry being processed. The report may be generated by compiling the tenant entries that meet the above match criteria into a report 136, and storing the report 136 in the database 130. The report 136 may include the match criteria for future reference, such as if the report 136 undergoes an update. The report 136 may also include links to each tenant entry in the group of matching tenant entries, and may be provided to a system user by displaying the report on the user interface, or transmitting the report to the user, e.g., as an attachment to an email.

Embodiments of the invention may also include a lead generation process that combs the database for any information that has been added or changed. The lead generation process may run continuously, periodically (e.g., during times of low server load), or in response to an event, such as an update to one or more database records. The lead generation process may compare new information found in the database 130 to see if there are any new matches. The lead generation process may then send an email or other electronic message to one or more of a tenant and the owner/broker of a matching property. This message may notify recipients of the new match and urge them to access the service. The lead generation process may also send messages to contacts in the system that have not subscribed to the service of potential matches.

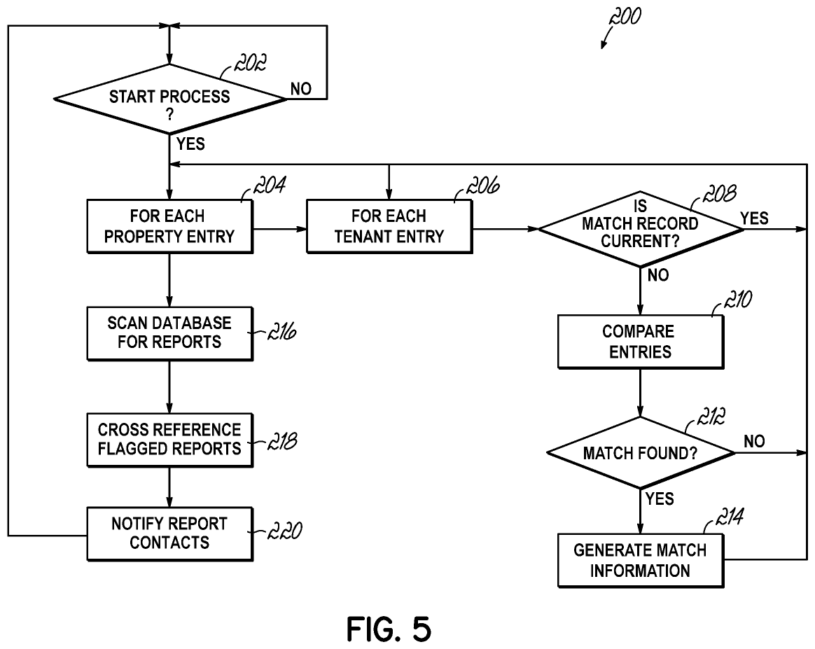

FIG. 5 depicts a flowchart illustrating an exemplary lead generation process 200 that may be executed by the data management system 104. The process 200 may be executed continually or periodically, and combs the database 130 for new matches between property entries and tenant entries. New matches may be found, for example, as existing property and tenant entries are updated, or as new property or tenant entries are added to the database 130. In block 202, the process 200 may wait for an event that indicates the process 200 should begin combing the database 130. Events that trigger execution of the process 200 may include manual activation by a user (e.g., after a user runs a report, or updates an entry for a property or a tenant), expiration of a timer that causes the process 200 to be executed on a predetermined schedule (e.g., overnight), or any other suitable event.

In response to being started, the process 200 may, as depicted by blocks 204 and 206, proceed to block 208 and determine if the property entry or tenant entry have been previously matched, and whether a previously existing match record is current. An existing match record may be considered current, for example, if neither entry associated with the match record has been updated since the match record was generated. Whether an existing match record is current or potentially out of date may be determined, for example, by comparing timestamps of the latest update to each of the property entry and the tenant entry to a time stamp on the match record associated with the pair. If a current match record exists (“YES” branch of decision block 208), the process 200 may return to block 206 and select the next tenant entry. If all tenant entries have been processed for the current property entry, the process may proceed to block 204 and select the next property entry. In either case, the process 200 may continue processing pairs of property and tenant entries until each property entry has been compared to each tenant entry.

In an alternative embodiment of the invention, the process 200 may skip block 208, and simply compare each property entry to each tenant entry without regard to whether an existing match record is current. In another alternative embodiment of the invention, process 200 may apply one or more attribute or requirement filters to the property or tenant entries to reduce the number of entry pairs that are compared. For example, for a particular property entry, a location filter could be implemented that filters out any tenant entry having a location requirement more than a predetermined distance from the property entry location attribute.

In response to determining that either a previous match record does not exist or is potentially out of date for the property-tenant entry pair (“NO” branch of decision block 208), the process 200 may proceed to block 210 and compare the attributes of the current property entry with the requirements of the current tenant entry. If the comparison produces a match (“YES” branch of decision block 212), the process 200 may proceed to block 214 and generate match information. Generating match information may include determining a match score for the property-tenant entry pair, and storing a match record in the database that is associated with the current property entry and the current tenant entry. The process 200 may also flag reports 136 associated with either of the current property entry and the current tenant entry, e.g., by associating the reports with the match record. The match record may identify the entries as being matching entries, include associated match score and match criteria data, and be entered into or indexed to an update list used for reviewing reports 136.

In response to the update list being generated or updated (i.e., all relevant property and tenant entries having been processed), the process 200 may proceed to block 216 and scan the database 130 for reports 136 that have been flagged as having one or more new matches, e.g., by comparing reports 136 against the update list. In block 218, the process 200 may cross- reference the flagged reports with user identities to identify users who are associated with at least one flagged report. The user identities may then be used to retrieve contact information for the user from their user profile, e.g., an email address for the user. Once the user contact information has been retrieved from the database 130, the process 200 may proceed to block 220 and send a notification to the user containing information about the new matches. New match information may include, for example, a summary, number of matches, which report the matches are for (in the event the user is associated with multiple property or tenant entries), and a button to view the reports or new matches, e.g., that activates a link to a web-page containing the reports.

By way of example, if a new match associated with a property or tenant entry appears in the update list, that new match may be reviewed to determine whether it should be added to or otherwise used to update an existing report 136 associated with one or both of the property and tenant entries. Existing reports 136 may be updated, or a new reports 136 generated, to reflect any new matches found by the match update process 200 in which the match score of the property-tenant pair satisfies the match criteria associated with the report 136. Depending on the method of determining which property or tenant entries are included in the report 136, the addition of a new entry may result in an existing entry being removed from the report 136. For example, for a ‘top 5’ match criteria, the new entry may take one of the ‘top 5’ positions and bump an existing entry having a lower match out of the report 136.

Upon completion of the review of the updated reports 136, one or more users associated with each updated report 136 may be notified of the new matching tenants or properties. The notification may be made by electronic communication and include details such as the number of additional matches. The notification may also include the updated report 136, a listing of the new or updated matches, or hyperlinks to view the updated report 136 having the new or updated matches. The process 200 may consolidate the electronic communication so that a single user associated with multiple property or tenant entries in the database 130 receives a single consolidated communication containing all relevant reports 136. The process 200 may also notify users of the data management system 104 that are associated with a property entry or a tenant entry having a new match even if they are not associated with a report 136 two which the match was added.

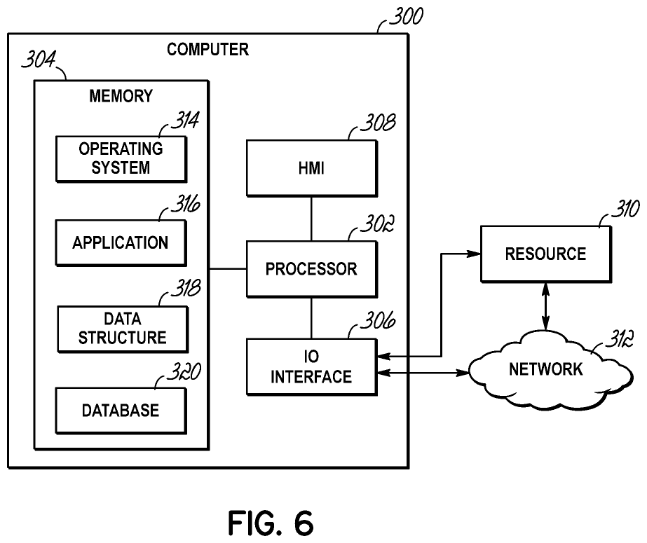

Referring now to FIG. 6, embodiments of the invention described above, or portions thereof, may be implemented using one or more computer devices or systems, such as exemplary computer 300. The computer 300 may include a processor 302, a memory 304, an input/output (I/O) interface 306, and a Human Machine Interface (HMI) 308. The computer 300 may also be operatively coupled to one or more external resources 310 via the network 312 or I/O interface 306. External resources may include, but are not limited to, servers, databases, mass storage devices, peripheral devices, cloud-based network services, or any other resource that may be used by the computer 300.

The processor 302 may include one or more devices selected from microprocessors, micro-controllers, digital signal processors, microcomputers, central processing units, field programable gate arrays, programmable logic devices, state machines, logic circuits, analog circuits, digital circuits, or any other devices that manipulate signals based on operational instructions stored in memory 304. Memory 304 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or data storage devices such as a hard drive, optical drive, tape drive, volatile or non-volatile solid state device, or any other device capable of storing data.

The processor 302 may operate under the control of an operating system 314 that resides in memory 304. The operating system 314 may manage computer resources so that computer program code embodied as one or more computer software applications, such as an application 316 residing in memory 304, or may have instructions executed by the processor 302. In an alternative embodiment, the processor 302 may execute the application 316 directly, in which case the operating system 314 may be omitted. One or more data structures 318 may also reside in memory 304, and may be used by the processor 302, operating system 314, or application 316 to store or manipulate data.

The I/O interface 306 may provide a machine interface that operatively couples the processor 302 to other devices and systems, such as the external resource 310 or the network 312. The application 316 may thereby work cooperatively with the external resource 310 or network 312 by communicating via the I/O interface 306 to provide the various features, functions, applications, processes, or modules comprising embodiments of the invention. The application 316 may also have program code that is executed by one or more external resources 310, or otherwise rely on functions or signals provided by other system or network components external to the computer 300. Indeed, given the nearly endless hardware and software configurations possible, persons having ordinary skill in the art will understand that embodiments of the invention may include applications that are located externally to the computer 300, distributed among multiple computers or other external resources 310, or provided by computing resources (hardware and software) that are provided as a service over the network 312, such as a cloud computing service.

The HMI 308 may be operatively coupled to the processor 302 of computer 300 to allow a user to interact directly with the computer 300. The HMI 308 may include any suitable audio, visual, or other indicators capable of providing data to the user. The HMI 308 may also include input devices and controls such as an alphanumeric keyboard, a pointing device, keypads, pushbuttons, control knobs, microphones, etc., capable of accepting commands or input from the user and transmitting the entered input to the processor 302.

A database 320 may reside in memory 304, and may be used to collect and organize data used by the various systems and modules described herein. The database 320 may include data and supporting data structures that store and organize the data. In particular, the database 320 may be arranged with any database organization or structure including, but not limited to, a relational database, a hierarchical database, a network database, or combinations thereof. A database management system in the form of a computer software application executing as instructions on the processor 302 may be used to access the information or data stored in records of the database 320 in response to a query, which may be dynamically determined and executed by the operating system 314, other applications 316, or one or more modules.

In general, the routines executed to implement the embodiments of the invention, whether implemented as part of an operating system or a specific application, component, program, object, module or sequence of instructions, or a subset thereof, may be referred to herein as “computer program code,” or simply “program code.” Program code typically comprises computer-readable instructions that are resident at various times in various memory and storage devices in a computer and that, when read and executed by one or more processors in a computer, cause that computer to perform the operations necessary to execute operations or elements embodying the various aspects of the embodiments of the invention. Computer- readable program instructions for carrying out operations of the embodiments of the invention may be, for example, assembly language, source code, or object code written in any combination of one or more programming languages.

Various program code described herein may be identified based upon the application within which it is implemented in specific embodiments of the invention. However, it should be appreciated that any particular program nomenclature which follows is used merely for convenience, and thus the invention should not be limited to use solely in any specific application identified or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a computer program product in a variety of different forms. In particular, the program code may be distributed using a computer- readable storage medium having computer-readable program instructions thereon for causing a processor to carry out aspects of the embodiments of the invention.

Computer-readable storage media, which is inherently non-transitory, may include volatile and non-volatile, and removable and non-removable tangible media implemented in any method or technology for storage of data, such as computer-readable instructions, data structures, program modules, or other data. Computer-readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store data and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

Computer-readable program instructions stored in a computer-readable medium may be used to direct a computer, other types of programmable data processing apparatuses, or other devices to function in a particular manner, such that the instructions stored in the computer- readable medium produce an article of manufacture including instructions that implement the functions, acts, or operations specified in the flow-charts, sequence diagrams, or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, or operations specified in the flow-charts, sequence diagrams, or block diagrams.

In certain alternative embodiments, the functions, acts, or operations specified in the flow-charts, sequence diagrams, or block diagrams may be re-ordered, processed serially, or processed concurrently consistent with embodiments of the invention. Moreover, any of the flow-charts, sequence diagrams, or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include both the singular and plural forms, and the term “or” is intended to include both alternative and conjunctive combinations, unless the context clearly indicates otherwise. It will be further understood that the terms “comprises” or “comprising,” when used in this specification, specify the presence of stated features, integers, actions, steps, operations, elements, or components, but do not preclude the presence or addition of one or more other features, integers, actions, steps, operations, elements, components, or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all the invention has been illustrated by a description of various embodiments, and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A system comprising:
one or more processors; and
a memory operatively coupled to the one or more processors and including program code that, when executed by the one or more processors, causes the system to:
maintain a database including a plurality of property entries and a plurality of tenant entries, each property entry defining one or more attributes of a property, and each tenant entry defining one or more requirements of a tenant;
select a first entry from one of the plurality of property entries or the plurality of tenant entries;
for each entry of the other of the plurality property entries or the plurality tenant entries:
compare each attribute or each requirement of the first entry to each requirement or each attribute of the other entry,
determine a match score based on the comparisons between the attributes and the requirements,
generate a match record in the database including the match score, and
associate the match record with a property-tenant entry pair defined by the first entry and the other entry; and
generate a first report identifying one or more properties or one or more tenants that match the property or the tenant associated with the first entry.

2. The system of claim 1, wherein the attributes include at least one of property data, traffic data, demographic data, address data, and location data.

3. The system of claim 1, wherein the program code causes the system to determine the match score by:
for each requirement:
determining if a corresponding attribute satisfies the requirement,
if the corresponding attribute satisfies the requirement, increasing a value of the match score, and
if the corresponding attribute does not satisfy the requirement, not increasing the value of the match score.

4. The system of claim 3, wherein an amount the value of the match score is increased depends at least in part on a type of the requirement being satisfied.

5. The system of claim 3, wherein an amount the value of the match score is increased depends at least in part on a weight associated with the requirement being satisfied.

6. The system of claim 1, wherein the first report is a property report, the first entry is a property entry, each of the other entries is a tenant entry, and the program code further causes the system to:
rank the tenant entries based on the match scores;
select one or more of the tenant entries based their rank; and
generate the property report that includes the one or more of the tenant entries.

7. The system of claim 1, wherein the first report is a tenant report, the first entry is a tenant entry, each of the other entries is a property entry, and the program code further causes the system to:
rank the property entries based on the match scores;
select one or more property entries based their rank; and
generate the tenant report that includes the one or more property entries.

8. The system of claim 1, wherein the program code further causes the system to, for each entry of the other of the plurality property entries or the plurality tenant entries:
determine if the match record exists for the property-tenant entry pair;
in response to the match record existing for the property-tenant entry pair, determine if the match record is current; and
if the match record does not exist, or is not current, generate a new match record.

9. The system of claim 8, wherein the program code further causes the system to:
scan the database for reports associated with either a property entry or a tenant entry of the property-tenant entry pair associated with each new match record; and
for each report identified by the scan:
rank the tenant entries or the property entries based on the match score of each property-tenant entry pair associated with the property entry or the tenant entry with which the report is associated,
select one or more of the tenant entries or the property entries based their rank, and
in response to the one or more tenant entries or the one or more property entries including a new entry, generate a new report that includes the one or more tenant entries or the one or more property entries.

10. The system of claim 9, wherein the program code further causes the system to:
in response to generation of each new report, transmit the new report to an electronic address associated with the property entry or the tenant entry to which the new report is associated.

11. A method comprising:
maintaining a database that includes a plurality of property entries and a plurality of tenant entries, each property entry defining one or more attributes of a property, and each tenant entry defining one or more requirements of a tenant;
selecting a first entry from one of the plurality of property entries or the plurality of tenant entries;
for each entry of the other of the plurality property entries or the plurality tenant entries:
comparing each attribute or each requirement of the first entry to each requirement or each attribute of the other entry,
determining a match score based on the comparisons between the attributes and the requirements,
generating a match record in the database including the match score, and
associating the match record with a property-tenant entry pair defined by the first entry and the other entry; and
generating a first report identifying one or more properties or one or more tenants that match the property or the tenant associated with the first entry.

12. The method of claim 11, wherein the attributes include at least one of property data, traffic data, demographic data, address data, and location data.

13. The method of claim 12, wherein determining the match score includes, for each requirement:
determining if a corresponding attribute satisfies the requirement;
if the corresponding attribute satisfies the requirement, increasing a value of the match score; and
if the corresponding attribute does not satisfy the requirement, not increasing the value of the match score.

14. The method of claim 13, wherein an amount the value of the match score is increased depends at least in part on a type of the requirement being satisfied.

15. The method of claim 13, wherein an amount the value of the match score is increased depends at least in part on a weight associated with the requirement being satisfied.

16. The method of claim 11, wherein the first report is a property report, the first entry is a property entry, each of the other entries is a tenant entry, and further including:
ranking the tenant entries based on the match scores;
selecting one or more of the tenant entries based their rank; and
generating the property report that includes the one or more of the tenant entries.

17. The method of claim 11, wherein the first report is a tenant report, the first entry is a tenant entry, each of the other entries is a property entry, and further including:
ranking the property entries based on the match scores;
selecting one or more property entries based their rank; and
generateing the tenant report that includes the one or more property entries.

18. The method of claim 11, further comprising, for each entry of the other of the plurality property entries or the plurality tenant entries:
determining if the match record exists for the property-tenant entry pair;
in response to the match record existing for the property-tenant entry pair, determining if the match record is current; and
if the match record does not exist, or is not current, generating a new match record.

19. The method of claim 18, further comprising:
scanning the database for reports associated with either a property entry or a tenant entry of the property-tenant entry pair associated with each new match record; and
for each report identified by the scan:
ranking the tenant entries or the property entries based on the match score of each property-tenant entry pair associated with the property entry or the tenant entry with which the report is associated,
selecting one or more of the tenant entries or the property entries based their rank,
in response to the one or more tenant entries or the one or more property entries including a new entry, generating a new report that includes the one or more tenant entries or the one or more property entries, and
in response to generation of each new report, transmitting the new report to an electronic address associated with the property entry or the tenant entry to which the new report is associated.

20. A computer program product comprising:
a non-transitory computer-readable storage medium; and
program code stored on the non-transitory computer-readable storage medium that, when executed by one or more processors, causes the one or more processors to:
maintain a database that includes a plurality of property entries and a plurality of tenant entries, each property entry defining one or more attributes of a property, and each tenant entry defining one or more requirements of a tenant;
select a first entry from one of the plurality of property entries or the plurality of tenant entries;
for each entry of the other of the plurality property entries or the plurality tenant entries:
compare each attribute or each requirement of the first entry to each requirement or each attribute of the other entry,
determine a match score based on the comparisons between the attributes and the requirements,
generate a match record in the database including the match score, and
associate the match record with a property-tenant entry pair defined by the first entry and the other entry; and
generate a first report identifying one or more properties or one or more tenants that match the property or the tenant associated with the first entry.
